(19) United States
(12) Patent Application Publication
(10) Pub. No.: US 2012/0085288 A1
(43) Pub. Date: Apr. 12, 2012

(54) Animal Feeder System with Remote Communication

(76) Inventors: Kenneth Salinas, Laredo, TX (US); Cordelia Salinas, Laredo, TX (US)

(21) Appl. No.: 12/898,838

(22) Filed: Oct. 6, 2010

(51) Int. Cl. A01K 5/02

(52) U.S. Cl. 119/51.02

(57) ABSTRACT

A game-animal (or other animal) feeding unit in combination with electronic sensors that monitor the status of the feeding unit. Among its features is a feed volume sensor that monitors the quantity of feed in its unit and wirelessly transmits that information to a distant location. The invention can dispense feed at programmed intervals, communicate feeder jams and battery-charge status. An optional GPS can provide location information of the unit.

### BACKGROUND

1. Field of the Invention

The present invention relates generally to animal-feeding devices used outdoors to feed livestock automatically or supplying food to game animals and more particularly to an animal feeder system with remote communication.

2. Description of the Prior Art

U.S. Pat. No. #3,195,508 is a game and stock feeder that is automatically operable to spread a desired amount of feed at a predetermined time and for a preselected period. It uses a timing mechanism and does not require the presence of an operator.

U.S. Pat. No. #6,779,487 is an automated livestock feeder for storing and dispensing food such as hay or granular feed in a feed container to an animal at predetermined intervals. It utilizes a tray control flange which releases a feed tray. At a predetermined feeding time, a motor rotates the flanged latch thereby releasing the tray to rotate from a storage position to a dispense position. The activation mechanism includes an electrical power source, a timer relay/mechanical switch, and an electrical motor.

U.S. Pat. No. #4,722,300 is a programmable, automatic feeder for pets and other animals that dispenses a measured amount of food at a predetermined time. A digital clock control mechanism, including an adjustable portion control knob, controls a battery-operated motor. The motor drives an eccentric weight to vibrate a vibrating conveyor pan attached to the motor.

U.S. Pat. No. #4,491,086 is an automatic animal feeder comprising a housing defining a feeding reservoir therein. An inlet opening is provided for receiving feed in the reservoir. An outlet is associated with a motor-driven discharge device for conveying feed to a remote discharge outlet. An automatic timer controls a drive for operating the discharge device at predetermined time intervals and for predetermined time periods to thereby control the quantity of feed discharged at the remote discharge outlet during each of the time intervals.

U.S. Pat. No. #4,235,200 is an automatic animal feeder comprising a housing with a hopper for storing large amounts of dry food, and a food-delivery chamber positioned below for holding a fixed portion of dry feed received from the hopper. The food delivery chamber pivots at regular intervals from a loading position to a delivery position whereby the fixed portion of dry feed is discharged into an area accessible to an animal.

U.S. Patent Application #20080029034 is a method and apparatus for automatic feeding of animals with a food hopper connected to a feeding trough. Bulk animal food loaded into the hopper transfers into the feeding trough. A lid covers the feeding trough, preventing access to the animal food. An automated drive mechanism having a timer opens the lid, thereby allowing access to the animal food in the feeding trough, at pre-set intervals. The automatic animal feeder can be used to train wild game to feed during certain desired periods, such as daylight hours.

None of the prior art offers the combination of animal-feeder with the capacity to communicate the device's feed levels, feeder jams, and battery-life status to a remote location.

### SUMMARY OF THE INVENTION

The present invention relates to a game or livestock feeding unit with remote communications. It is an object of this invention to provide a game-animal feeding unit in combination with electronic sensors that monitor the status of the feeding unit. Among its features is a volume sensor that monitors the quantity of feed in its unit and transmits that information to a distant location. Another object of this invention is to dispense feed at programmed intervals, and to communicate feeder jams and battery-life status. In addition, the unit prevents unwanted animals from accessing the feed inside the feeding unit. An optional GPS can be provided that can be interrogated or can report location.

Other objects of the present invention, as well as particular features, elements, and advantages thereof, will be shown in the following description and accompanying figures.

### DESCRIPTION OF THE FIGURES

Attention is now directed to several illustrations to better understand features of the present invention.

FIG. 1 an isometric view of the embodiment.

FIG. 2 is a detailed view showing the embodiment engaged with a feed container.

FIG. 3 is a perspective view of the primary components of the embodiment.

FIG. 4 is a detailed view of the communication ports.

FIG. 5 is a section view of the mechanical and electrical parts of the embodiment.

Several drawings have been presented to aid in understanding the invention. The scope of the present invention is not limited to what is shown in the figures.

### DESCRIPTION OF THE INVENTION

The present invention relates to an animal feeder with remote communications that can report quantity of feed remaining, battery status and can dispense on a predetermined schedule.

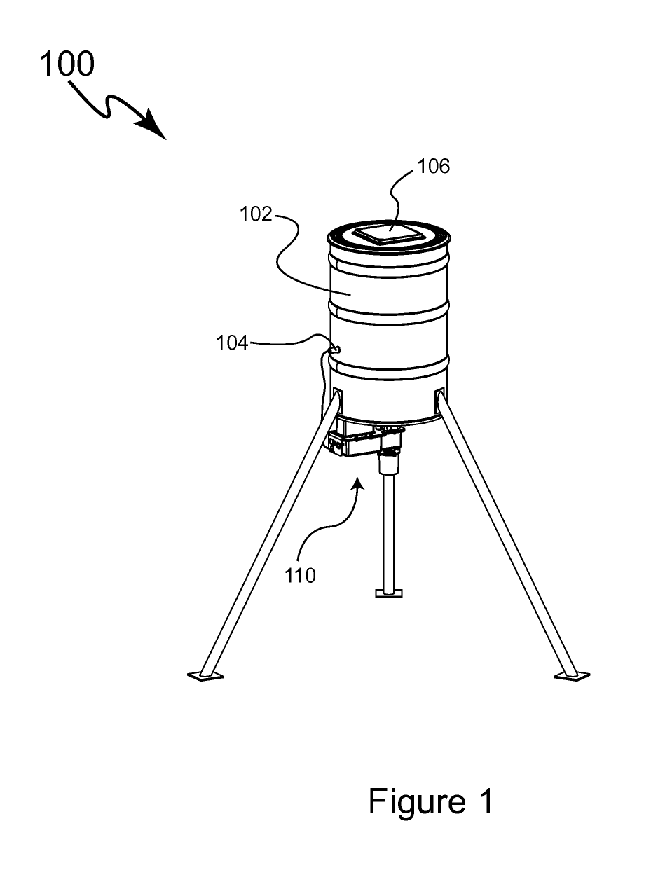

Referring to FIG. 1, the present invention is a game-animal feeder 100 that can include a feed drum 102, that holds feed, and a volume sensor 104 and solar panel 106 on the feed drum. A feed-dispersion mechanism in combination with a data acquisition unit and remote communication module 110 are generally attached to the underside of the feed drum 102.

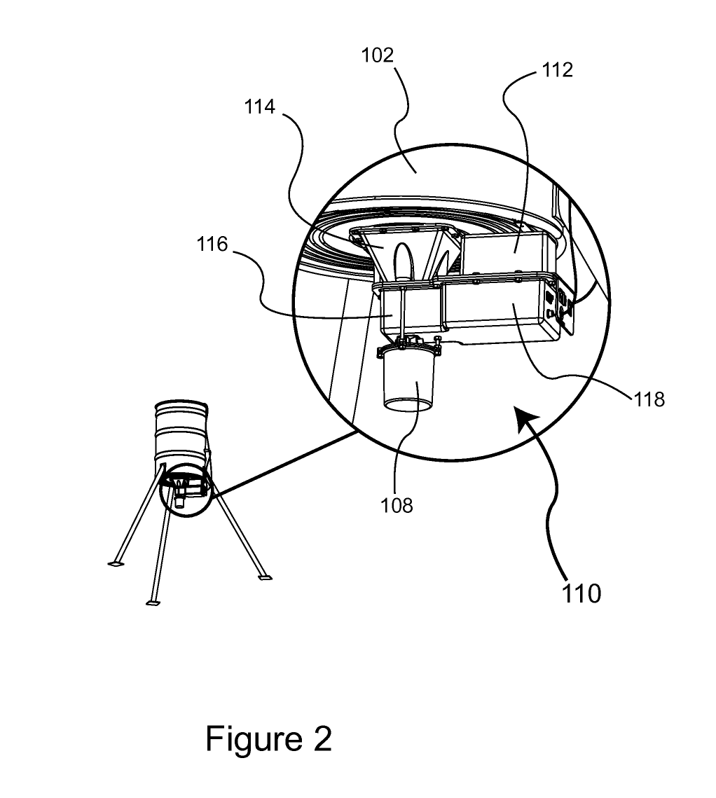

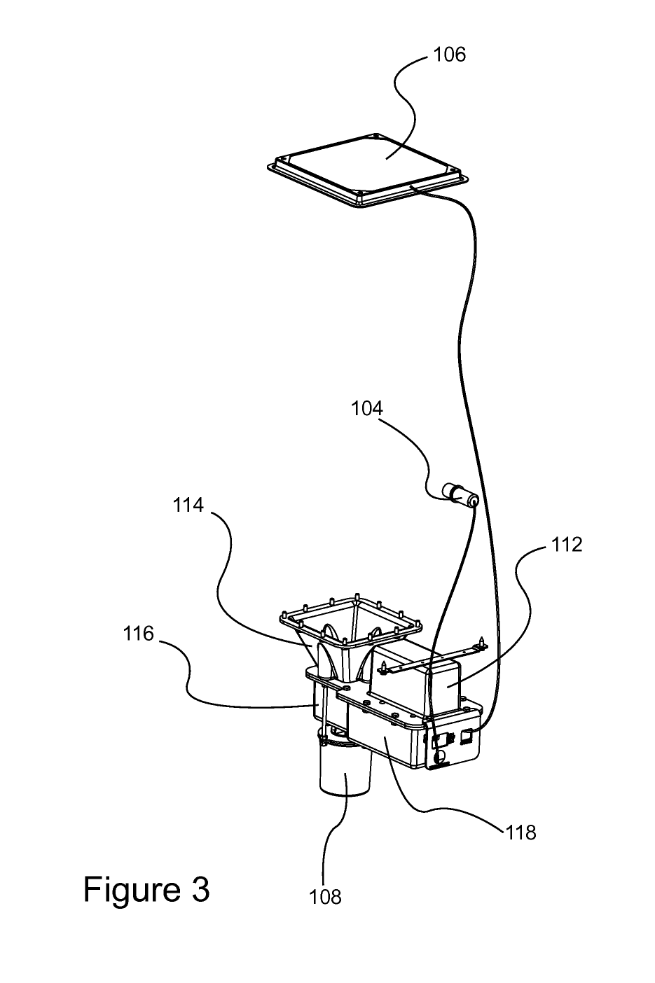

Referring to FIGS. 2 and 3, an embodiment of the system is shown without the feed drum. The feed-dispersion mechanism, in combination 110 with a data acquisition unit and remote communication module includes a battery 112 and communication housing attached to a drive-unit housing 118 that is connected to a feed spreader 116. The feed spreader 116 couples to a motor 108 and a funnel 114. The feed-funnel 114 is shown connected to the underside of the feed drum. The combination 110 is generally attached to the bottom portion of a feed drum 102 (FIG. 2); however, any other location is within the scope of the present invention. A solar panel 106 (FIG. 3) provides power to the unit and is connected with the unit via a power transmission line. A volume sensor 104 is normally attached to the unit.

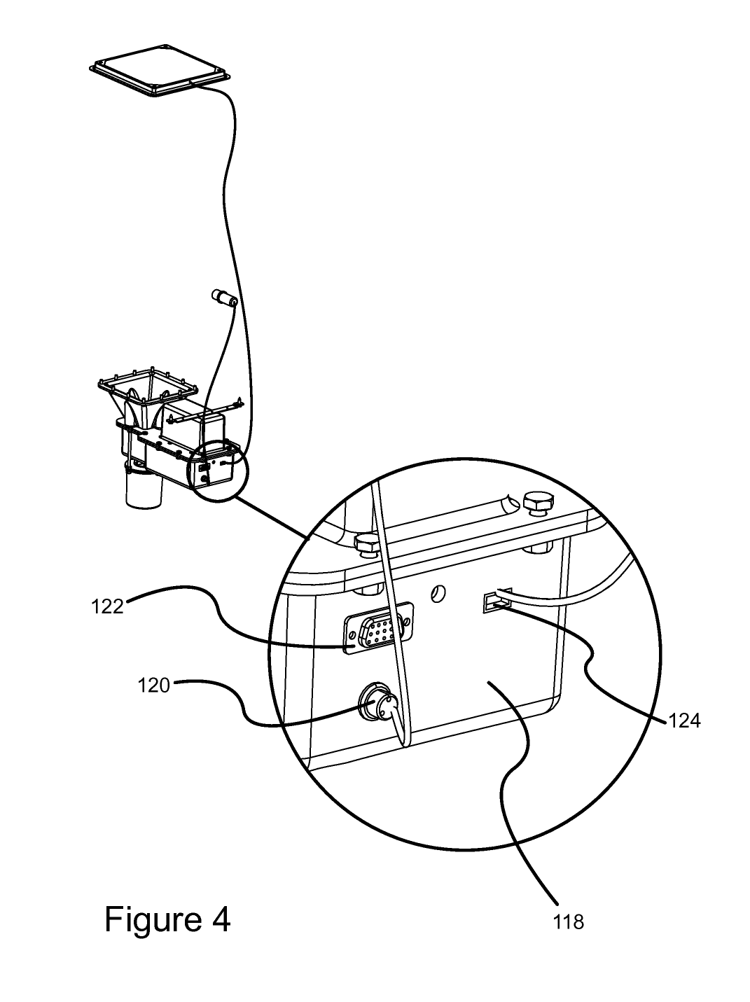

Referring to FIG. 4, a detailed view of the embodiment illustrates various electronic and communication ports engaged with the housing 118 including an information port 122, a power input 124 and a feed-level-sensor input 120.

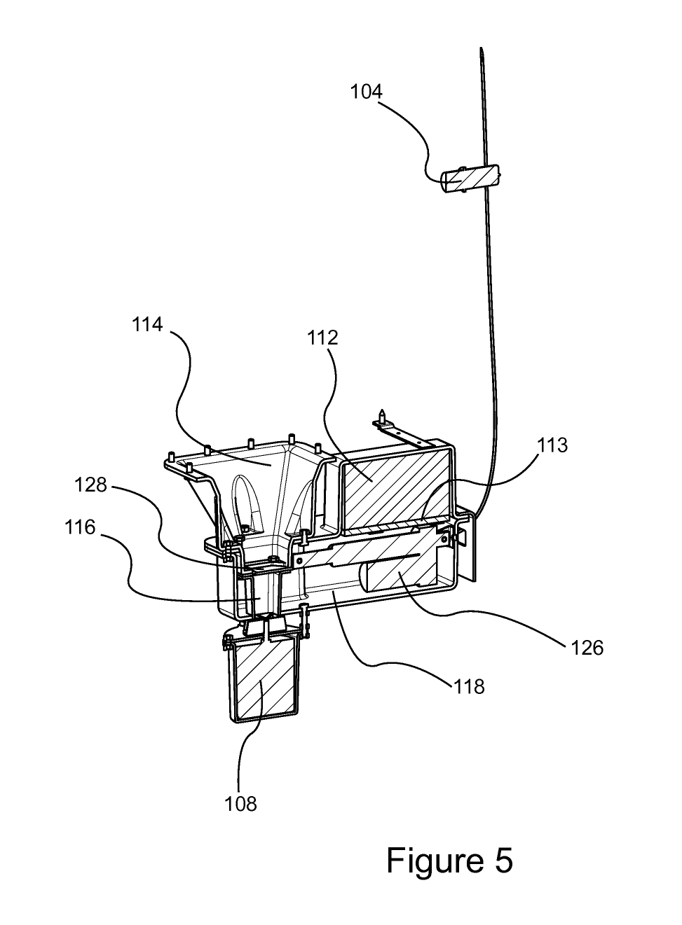

FIG. 5 is a cut-away view of the combination 110. The motor 108 is rotationally engaged with the feed-dispersion device 116 that is attached to the funnel 114. The path from the funnel to the feed-dispersion device 116 is opened or closed by a slide gate 128. The slide gate is controlled by a linear actuator 126 such that when power is supplied to it, the slide gate 128 can be either opened or closed. When the slide gate is in the open position, the feed dispersion device 116 can be rotated to disperse feed to the funnel. When there is no power, for whatever reason, the slide gate 128 is normally closed.

A circuit board 113 is equipped with the power and communication ports shown in FIG. 4. Communication and computing technology including a processor or central processing unit (CPU), a programmable logic controller (PLC) or the like are typically employed and not shown in detail, but are represented by circuit board 113. Any processor, microprocessor, controller, microcontroller, PLC or other computing device is within the scope of the present invention. A timer in the processor or on the circuit board 113 initiates the feed-dispersion process by sending power from the battery 112, to the linear actuator 126, thus opening the slide gate 128 and then supplying power to the motor 108 to rotate the feed dispersion device 116 that disperses feed from the funnel 114.

Feed quantity information from the volume sensor 104 is supplied to the processor as often as necessary. A low-volume signal from the volume sensor 104 can shut down the feed-dispersion process and send a signal to a remote location via wireless communication technology. Alternatively, the feed quantity, battery charge and/or other parameters can be transmitted on a schedule or can be interrogated from a remote station.

The combination 110 also includes a wireless communication module on the circuit board 113 or elsewhere. The wireless communications module can communicate with a remote location via cellular telephone, WiFi, satellite telephone or other satellite communications, or by any other wireless technique. The preferred communications technique is either cellular telephone or satellite telephone. The communications can be one direction from the feeder to the remote location to report acquired data, or it can optionally be bi-directional. Data can be optionally acquired regarding feed level, battery status, feed jams or any other acquired data parameter.

The combination 110 can optionally contain a GPS receiver on the circuit card 113 or elsewhere that can be aware of the feeder's location. Bi-directional wireless communication can optionally interrogate the GPS as to location. This can be useful to determine if a remote feeder has been moved, etc. The system could report location periodically or upon interrogation.

Several descriptions and illustrations have been provided to aid in understanding the present invention. One with skill in the art will realize that numerous changes and variations are possible without departing from the spirit of the invention. Each of these changes and variations are within the scope of the present invention.

We claim:

1. An remote animal feeding unit comprising: feed supply, power supply, and feed dispenser, said unit dispensing animal feed at predetermined intervals; said unit also including a feed-level monitor electrically coupled to a wireless transmitter that communicates feed level information to a location remote from said feeding unit.

2. The remote animal feeding unit of claim 1 further comprising a solar panel and rechargeable battery.

3. The remote animal feeding unit of claim 1 wherein said unit communicates wirelessly by cellular telephone or satellite.

4. The remote animal feeding unit of claim 1 further comprising a GPS receiver.

5. The remote animal feeding unit of claim 1 further comprising a processor.

6. The remote animal feeding unit of claim 1 wherein said unit also communicates information related to battery charge.

7. A unit for providing feed to animals comprising, in combination:
a feed supply;
a feed quantity sensor measuring said feed supply;
a battery;
a motor powered by said battery;
a feed dispersion device mechanically coupled to said motor;
a timer;
wherein, when said timer indicates a particular time, said motor is activated from said battery to run said feed dispersion device dispensing feed;
and wherein, information from said feed quantity sensor is transmitted wirelessly to a remote location.

8. The unit of claim 7 further comprising a solar panel charging said battery.

9. The unit of claim 7 wherein information concerning battery charge state is also transmitted wirelessly to said remote location.

10. The unit of claim 7 wherein said information is transmitted by cellular telephone or by satellite signal.

11. The unit of claim 7 further comprising a GPS.

12. A method of feeding animals remotely comprising:
placing a feed dispenser unit at a remote location;
causing said feed dispenser unit to dispense feed at particular times or particular intervals;
wirelessly transmitting feed quantity information from said feed dispenser to a second location.

13. The method of claim 12 wherein said feed dispenser contains a processor.

14. The method of claim 12 wherein said feed dispenser contains a feed-level sensor and a battery charge sensor; and
wireless transmitting battery charge information from said feed dispenser to said second location.

15. The method of claim 12 wherein said feed dispenser contains a GPS and can be interrogated from said second location as to said feed dispenser's location.

16. The method of claim 12 wherein said transmitting is by cellular telephone or satellite signal.

17. The method of claim 12 wherein said feed dispenser can be interrogated as to feed level from said second location.
